(19) United States
(12) Patent Application Publication
(10) Pub. No.: US 2018/0189597 A1
(43) Pub. Date: Jul. 5, 2018

(54) Training an Image Classifier

(71) Applicant: Facebook, Inc., Menlo Park, CA (US)

(72) Inventors: Nikhil Johri, Mountain View, CA (US); Kevin Brian Chen, Sunnyvale, CA (US); Dario Garcia Garcia, Redwood City, CA (US); Balmanohar Paluri, Mountain View, CA (US)

(21) Appl. No.: 15/395,328

(22) Filed: Dec. 30, 2016

(51) Int. Cl. G06K 9/46; G06K 9/62; H04L 29/08

(52) U.S. Cl. CPC G06K 9/4671; G06K 9/6232; H04L 67/22; H04L 67/306; H04L 67/10

(57) ABSTRACT

In one embodiment, a method includes accessing for each of a plurality of input images a feature vector corresponding to the input image and metadata indicating a relationship of the input image to a predetermined concept; training with machine learning an image classifier associated with the predetermined concept based on the feature vectors of the input images and the metadata indicating their respective relationships to the predetermined concept; accessing for each of a plurality of evaluation images a feature vector that corresponds to the evaluation image; for each evaluation image calculating with the image classifier as trained a score indicating how closely related the evaluation image is to the predetermined concept, based on the feature vector corresponding to the evaluation image; and providing for display to a user one or more of the evaluation images and their respective scores as calculated by the image classifier.

### TECHNICAL FIELD

This disclosure generally relates to computer vision.

### BACKGROUND

Computer vision is a computational process (or set of computational processes) that facilitates machine understanding of the content of an image or set of images, such as a video. For example, computer vision may involve automatically extracting features from an image, analyzing them, and generating an explicit description or categorization of the image. Applications of computer vision include controlling processes and systems, navigation, event detection, organizing information, modeling objects or environments, and automatic inspection.

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

### SUMMARY OF PARTICULAR EMBODIMENTS

In particular embodiments, social-networking system 160 may provide a computer-vision platform that includes data addition, training, and evaluation modules. A computer-vision platform may be used to train an image classifier by machine learning to recognize a particular concept. A data addition module may receive input images or feature vectors representing input images. The data addition module may generate feature vectors for input images. The data addition module may also be used to access metadata associated with the predetermined concept for each input image or feature vector. An evaluation module may access a set of evaluation images and generate results from the image classifier for each evaluation image. The evaluation module may display to a user the evaluation images and the results. The training module may train an image classifier by machine learning using the feature vectors and associated metadata. A visual-recognition engine may be a collection of one or more image classifiers associated with one or more respective predetermined concepts. As an example and not by way of limitation, a visual-recognition engine may comprise an image classifier associated with images of dogs and an image classifier associated with images of cats. The data addition, training, and evaluation modules may be independent and interchangeable. As an example and not by way of limitation, the data training module may use a different algorithm to generate feature vectors for input images than the algorithm used by the training module to train the image classifier. As another example and not by way of limitation, the image classifiers of a visual recognition engine may be trained using different algorithms. Although this disclosure describes providing a computer-vision platform in a particular manner, this disclosure contemplates providing a computer-vision platform in any suitable manner.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment associated with a social-networking system.

FIG. 2 illustrates an example social graph.

FIG. 3 illustrates an example vector space.

FIG. 4 illustrates an example user interface for creating a new image classifier associated with a predetermined concept.

FIG. 5 illustrates example user interfaces for adding training data.

FIG. 6 illustrates an example user interface for training an image classifier.

FIG. 7 illustrates an example user interface for displaying to a user input images and their respective scores.

FIG. 8 illustrates an example user interface for displaying to a user evaluation images and their respective scores.

FIG. 9 illustrates an example display metric associated with viewing input images.

FIG. 10 illustrates an example display metric associated with viewing evaluation images.

FIG. 11 illustrates an example display metric associated with training.

FIG. 12 illustrates an example method for training an image classifier.

FIG. 13 illustrates an example computer system.

### DESCRIPTION OF EXAMPLE EMBODIMENTS

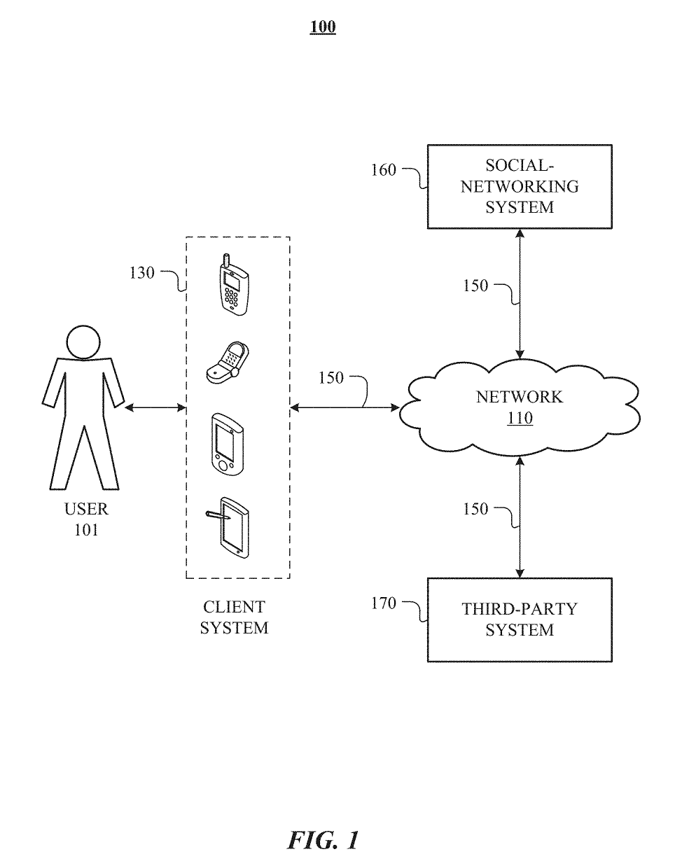

FIG. 1 illustrates an example network environment 100 associated with a social-networking system. Network environment 100 includes a user 101, a client system 130, a social-networking system 160, and a third-party system 170 connected to each other by a network 110. Although FIG. 1 illustrates a particular arrangement of user 101, client system 130, social-networking system 160, third-party system 170, and network 110, this disclosure contemplates any suitable arrangement of user 101, client system 130, social-networking system 160, third-party system 170, and network 110. As an example and not by way of limitation, two or more of client system 130, social-networking system 160, and third-party system 170 may be connected to each other directly, bypassing network 110. As another example, two or more of client system 130, social-networking system 160, and third-party system 170 may be physically or logically co-located with each other in whole or in part. Moreover, although FIG. 1 illustrates a particular number of users 101, client systems 130, social-networking systems 160, third-party systems 170, and networks 110, this disclosure contemplates any suitable number of users 101, client systems 130, social-networking systems 160, third-party systems 170, and networks 110. As an example and not by way of limitation, network environment 100 may include multiple users 101, client system 130, social-networking systems 160, third-party systems 170, and networks 110.

In particular embodiments, user 101 may be an individual (human user), an entity (e.g., an enterprise, business, or third-party application), or a group (e.g., of individuals or entities) that interacts or communicates with or over social-networking system 160. In particular embodiments, social-networking system 160 may be a network-addressable computing system hosting an online social network. Social-networking system 160 may generate, store, receive, and send social-networking data, such as, for example, user-profile data, concept-profile data, social-graph information, or other suitable data related to the online social network. Social-networking system 160 may be accessed by the other components of network environment 100 either directly or via network 110. In particular embodiments, social-networking system 160 may include an authorization server (or other suitable component(s)) that allows users 101 to opt in to or opt out of having their actions logged by social-networking system 160 or shared with other systems (e.g., third-party systems 170), for example, by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers may be used to enforce one or more privacy settings of the users of social-networking system 30 through blocking, data hashing, anonymization, or other suitable techniques as appropriate. Third-party system 170 may be accessed by the other components of network environment 100 either directly or via network 110. In particular embodiments, one or more users 101 may use one or more client systems 130 to access, send data to, and receive data from social-networking system 160 or third-party system 170. Client system 130 may access social-networking system 160 or third-party system 170 directly, via network 110, or via a third-party system. As an example and not by way of limitation, client system 130 may access third-party system 170 via social-networking system 160. Client system 130 may be any suitable computing device, such as, for example, a personal computer, a laptop computer, a cellular telephone, a smartphone, a tablet computer, or an augmented/virtual reality device.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect client system 130, social-networking system 160, and third-party system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

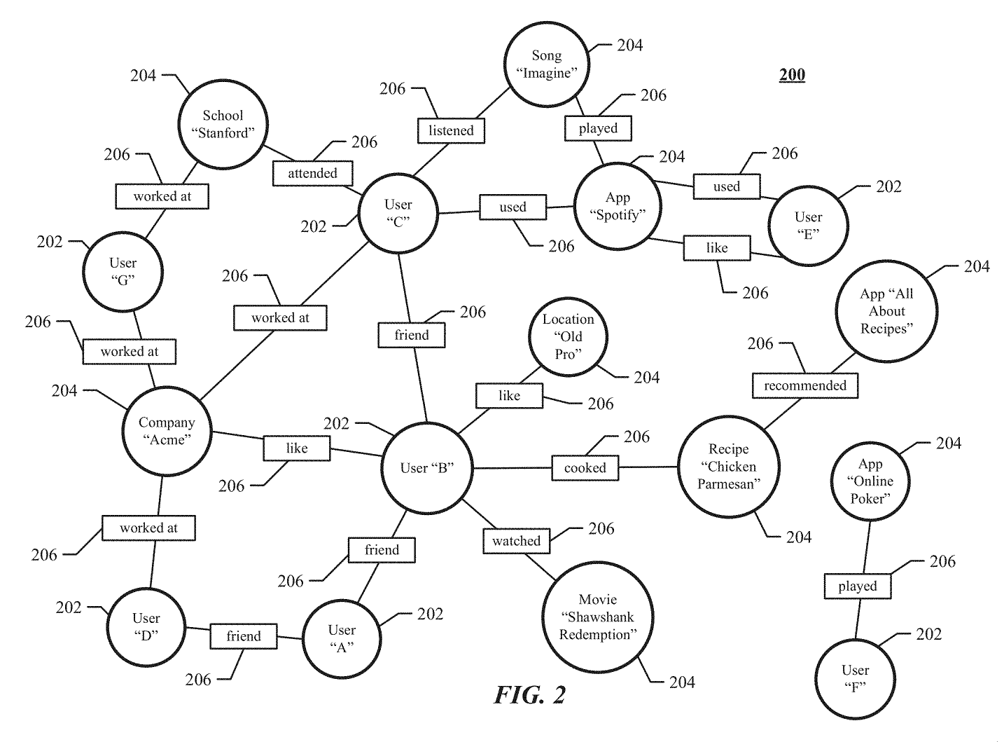

FIG. 2 illustrates example social graph 200. In particular embodiments, social-networking system 160 may store one or more social graphs 200 in one or more data stores. In particular embodiments, social graph 200 may include multiple nodes—which may include multiple user nodes 202 or multiple concept nodes 204—and multiple edges 206 connecting the nodes. Example social graph 200 illustrated in FIG. 2 is shown, for didactic purposes, in a two-dimensional visual map representation. In particular embodiments, a social-networking system 160, client system 130, or third-party system 170 may access social graph 200 and related social-graph information for suitable applications. The nodes and edges of social graph 200 may be stored as data objects, for example, in a data store (such as a social-graph database). Such a data store may include one or more searchable or queryable indexes of nodes or edges of social graph 200.

In particular embodiments, a user node 202 may correspond to a user of social-networking system 160. As an example and not by way of limitation, a user may be an individual (human user), an entity (e.g., an enterprise, business, or third-party application), or a group (e.g., of individuals or entities) that interacts or communicates with or over social-networking system 160. In particular embodiments, when a user registers for an account with social-networking system 160, social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with social-networking system 160. In particular embodiments, a user node 202 may be associated with information provided by a user or information gathered by various systems, including social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more webpages.

In particular embodiments, a concept node 204 may correspond to a concept. As an example and not by way of limitation, a concept may correspond to a place (such as, for example, a movie theater, restaurant, landmark, or city); a website (such as, for example, a website associated with social-network system 160 or a third-party website associated with a web-application server); an entity (such as, for example, a person, business, group, sports team, or celebrity); a resource (such as, for example, an audio file, video file, digital photo, text file, structured document, or application) which may be located within social-networking system 160 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 204 may be associated with information of a concept provided by a user or information gathered by various systems, including social-networking system 160. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more webpages.

In particular embodiments, a node in social graph 200 may represent or be represented by a webpage (which may be referred to as a “profile page”). Profile pages may be hosted by or accessible to social-networking system 160. Profile pages may also be hosted on third-party websites associated with a third-party system 170. As an example and not by way of limitation, a profile page corresponding to a particular external webpage may be the particular external webpage and the profile page may correspond to a particular concept node 204. Profile pages may be viewable by all or a selected subset of other users. As an example and not by way of limitation, a user node 202 may have a corresponding user-profile page in which the corresponding user may add content, make declarations, or otherwise express himself or herself. As another example and not by way of limitation, a concept node 204 may have a corresponding concept-profile page in which one or more users may add content, make declarations, or express themselves, particularly in relation to the concept corresponding to concept node 204.

In particular embodiments, a concept node 204 may represent a third-party webpage or resource hosted by a third-party system 170. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 130 to send to social-networking system 160 a message indicating the user's action. In response to the message, social-networking system 160 may create an edge (e.g., a check-in-type edge) between a user node 202 corresponding to the user and a concept node 204 corresponding to the third-party webpage or resource and store edge 206 in one or more data stores.

In particular embodiments, a pair of nodes in social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, social-networking system 160 may send a “friend request” to the second user. If the second user confirms the “friend request,” social-networking system 160 may create an edge 206 connecting the first user's user node 202 to the second user's user node 202 in social graph 200 and store edge 206 as social-graph information in one or more of data stores 164. In the example of FIG. 2, social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to an edge type or subtype. A concept-profile page corresponding to a concept node 204 may include, for example, a selectable “check in” icon (such as, for example, a clickable “check in” icon) or a selectable “add to favorites” icon. Similarly, after a user clicks these icons, social-networking system 160 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, social-networking system 160 may create an edge 206 between a user node 202 and a concept node 204 in social graph 200. As an example and not by way of limitation, a user viewing a concept-profile page (such as, for example, by using a web browser or a special-purpose application hosted by the user's client system 130) may indicate that he or she likes the concept represented by the concept node 204 by clicking or selecting a “Like” icon, which may cause the user's client system 130 to send to social-networking system 160 a message indicating the user's liking of the concept associated with the concept-profile page. In response to the message, social-networking system 160 may create an edge 206 between user node 202 associated with the user and concept node 204, as illustrated by “like” edge 206 between the user and concept node 204. In particular embodiments, social-networking system 160 may store an edge 206 in one or more data stores. In particular embodiments, an edge 206 may be automatically formed by social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

In particular embodiments, social-networking system 160 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 170 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 160 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of a observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 160 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, social-networking system 160 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 160 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 160 may calculate a coefficient based on a user's actions. Social-networking system 160 may monitor such actions on the online social network, on a third-party system 170, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular embodiments, social-networking system 160 may calculate a coefficient based on the user's actions with particular types of content. The content may be associated with the online social network, a third-party system 170, or another suitable system. The content may include users, profile pages, posts, news stories, headlines, instant messages, chat room conversations, emails, advertisements, pictures, video, music, other suitable objects, or any combination thereof. Social-networking system 160 may analyze a user's actions to determine whether one or more of the actions indicate an affinity for subject matter, content, other users, and so forth. As an example and not by way of limitation, if a user frequently posts content related to “coffee” or variants thereof, social-networking system 160 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 160 may calculate a coefficient based on the type of relationship between particular objects. Referencing the social graph 200, social-networking system 160 may analyze the number and/or type of edges 206 connecting particular user nodes 202 and concept nodes 204 when calculating a coefficient. As an example and not by way of limitation, user nodes 202 that are connected by a spouse-type edge (representing that the two users are married) may be assigned a higher coefficient than a user nodes 202 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in a first photo, but merely likes a second photo, social-networking system 160 may determine that the user has a higher coefficient with respect to the first photo than the second photo because having a tagged-in-type relationship with content may be assigned a higher weight and/or rating than having a like-type relationship with content. In particular embodiments, social-networking system 160 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 160 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 200. As an example and not by way of limitation, social-graph entities that are closer in the social graph 200 (i.e., fewer degrees of separation) may have a higher coefficient than entities that are further apart in the social graph 200.

In particular embodiments, social-networking system 160 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 130 of the user). A first user may be more interested in other users or concepts that are closer to the first user. As an example and not by way of limitation, if a user is one mile from an airport and two miles from a gas station, social-networking system 160 may determine that the user has a higher coefficient for the airport than the gas station based on the proximity of the airport to the user.

In particular embodiments, social-networking system 160 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 160 may provide information that is relevant to user's interests and current circumstances, increasing the likelihood that they will find such information of interest. In particular embodiments, social-networking system 160 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 160 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 160 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 170 (e.g., via an API or other communication channel), or from another suitable system. In response to the request, social-networking system 160 may calculate the coefficient (or access the coefficient information if it has previously been calculated and stored). In particular embodiments, social-networking system 160 may measure an affinity with respect to a particular process. Different processes (both internal and external to the online social network) may request a coefficient for a particular object or set of objects. Social-networking system 160 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 01 Oct. 2012, each of which is incorporated by reference as an example and not by way of limitation.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page that identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 204 corresponding to a particular photo may have a privacy setting specifying that the photo may only be accessed by users tagged in the photo and their friends. In particular embodiments, privacy settings may allow users to opt in or opt out of having their actions logged by social-networking system 160 or shared with other systems (e.g., third-party system 170). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 170, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers 162 may be authorization/privacy servers for enforcing privacy settings. In response to a request from a user (or other entity) for a particular object stored in a data store 164, social-networking system 160 may send a request to the data store 164 for the object. The request may identify the user associated with the request and may only be sent to the user (or a client system 130 of the user) if the authorization server determines that the user is authorized to access the object based on the privacy settings associated with the object. If the requesting user is not authorized to access the object, the authorization server may prevent the requested object from being retrieved from the data store 164, or may prevent the requested object from being sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

In particular embodiments, social-networking system 160 may provide a computer-vision platform. Computer vision may involve the automatic extraction, analysis, and understanding of images or a sequence of images (e.g., a video). A computer-vision platform may output a description of an image, such as the presence of an object, a description of the context of the image, or any other suitable description. The input for a computer-vision platform may be a feature vector representation of an image, which may an array of numerical features associated with an image. An image itself may be the input for a computer-vision platform and the computer-vision platform may generate a feature vector for the image. Although this disclosure describes a particular computer-vision platform, this disclosure contemplates any suitable computer-vision platform.

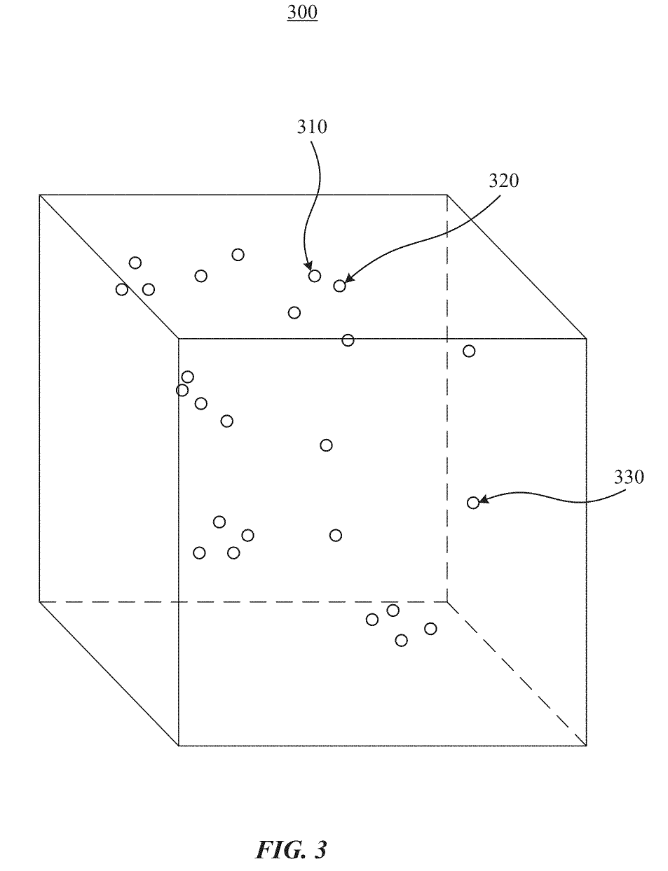

FIG. 3 illustrates an example vector space 300, which may be used to represent an image or set of images with a feature vector. In particular embodiments, an image may be represented in a d-dimensional vector space, where d denotes any suitable number of dimensions. Vector space 300 may also be referred to as a feature space. Although vector space 300 is illustrated as a three-dimensional space, this is for illustrative purposes only, as vector space 300 may be of any suitable dimension. In particular embodiments, an image may be represented in vector space 300 as a vector referred to as a feature vector. Each vector may comprise coordinates corresponding to a particular point in vector space 300 (i.e., the terminal point of the vector). As an example and not by way of limitation, feature vectors 310, 320, and 330 may be represented as points in vector space 300, as illustrated in FIG. 3. An image may be mapped to a respective vector representation. As an example and not by way of limitation, images t₁ and t₂ may be mapped to feature vectors \vec{v}₁ and \vec{v}₂ in vector space 300, respectively, by applying a function \vec{π}. The function \vec{π} may map images to feature vectors by feature extraction, which may start from an initial set of measured data and build derived values (e.g., features). When an input image has data that is either too large to be efficiently processed or comprises redundant data, \vec{π} may map the image to a feature vector using a transformed reduced set of features (e.g., feature selection). A feature vector may comprise information related to the image. In particular embodiments, an image may be mapped to a vector representation in vector space 300 by using an algorithm used to detect or isolate various desired portions or shapes of the image. As an example and not by way of limitation, features of the feature vector may be based on information obtained from edge detection, corner detection, blob detection, ridge detection, scale-invariant feature transformation, edge direction, changing intensity, autocorrelation, motion detection, optical flow, thresholding, blob extraction, template matching, Hough transformation (e.g., lines, circles, ellipses, arbitrary shapes), or any other suitable information. In particular embodiments, social-networking system 160 may utilize one or more systems, components, elements, functions, methods, operations, or steps disclosed in U.S. patent application Ser. No. 14/981,413, filed 28 Dec. 2015, which is incorporated herein by reference as an example and not by way of limitation. Although this disclosure describes representing an image in a vector space in a particular manner, this disclosure contemplates representing an image in a vector space in any suitable manner.

In particular embodiments, social-networking system 160 may calculate a similarity metric of feature vectors in vector space 300. A similarity metric may be a cosine similarity, a Minkowski distance, a Mahalanobis distance, a Jaccard similarity coefficient, or any other suitable similarity metric. As an example and not by way of limitation, a similarity metric of \vec{v}₁ and \vec{v}₂ may be a cosine similarity

$$\frac{\vec{{v}_{1}} \cdot \vec{{v}_{2}}}{‖ \vec{{v}_{1}} ‖ ‖ \vec{{v}_{2}} ‖} .$$

As another example and not by way of limitation, a similarity metric of \vec{v}₁ and \vec{v}₂ may be a Euclidean distance ∥\vec{v}₁−\vec{v}₂∥. A similarity metric of two feature vectors may represent how similar the two objects corresponding to the two feature vectors, respectively, are to one another, as measured by the distance between the two feature vectors in vector space 300. As an example and not by way of limitation, feature vector 310 and feature vector 320 may correspond to images that are more similar to one another than the images corresponding to feature vector 310 and feature vector 330, based on the distance between the respective feature vectors. Although this disclosure describes calculating similarity metrics in a particular manner, this disclosure contemplates calculating similarity metrics in any suitable manner.

In particular embodiments, social-networking system 160 may provide a computer-vision platform that includes data addition, training, and evaluation modules. A computer-vision platform may be used to train an image classifier by machine learning to recognize a particular concept. A data addition module may receive input images or feature vectors representing input images. The data addition module may generate feature vectors for the input images. The data addition module may also be used to access metadata associated with a predetermined concept for each input image or feature vector. The training module may train an image classifier by machine learning using the feature vectors and associated metadata. The training module may allow a user to view, alter, or otherwise change the metadata for an input image. The training module may display input images along with scores representing the relatedness of the input images to the predetermined concept calculated by the image classifier as trained. An evaluation module may access a set of evaluation images and display the evaluation images along with scores representing the relatedness of the evaluation images to the predetermined concept calculated by the image classifier as trained. A visual-recognition engine may be a collection of one or more image classifiers associated with one or more respective predetermined concepts. As an example and not by way of limitation, a visual-recognition engine may comprise an image classifier associated with images of dogs and an image classifier associated with images of cats. The data addition, training, and evaluation modules may be independent and interchangeable. As an example and not by way of limitation, the data training module may use a different algorithm to generate feature vectors for input images than the algorithm used by the training module to train the image classifier. As another example and not by way of limitation, a plurality of image classifiers of a visual recognition engine may each be trained using different algorithms. Although this disclosure describes providing a computer-vision platform in a particular manner, this disclosure contemplates providing a computer-vision platform in any suitable manner.

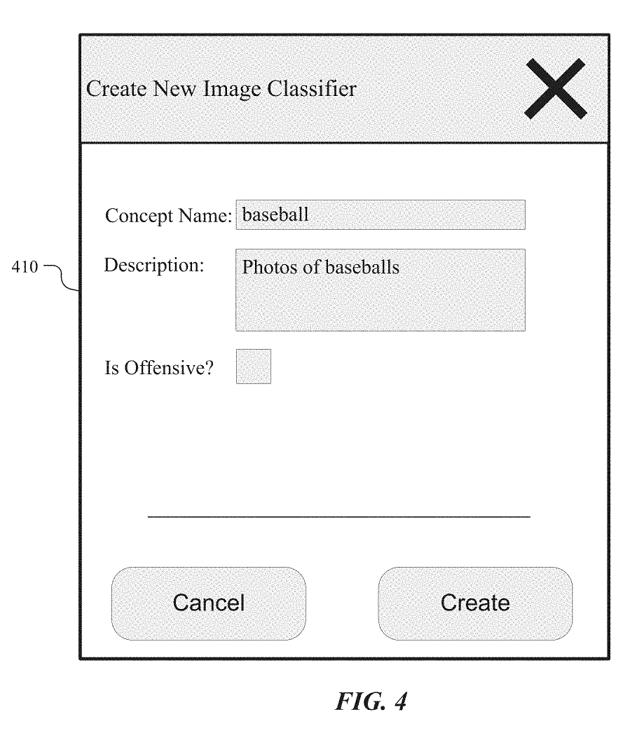

FIG. 4 illustrates an example user interface (UI) 410 for creating a new image classifier associated with a predetermined concept. In particular embodiments, a computer-vision platform may allow a user to create a new image classifier. The image classifier may be associated with a predetermined concept. The image classifier may be trained to recognize instances of the predetermined concept in images. As an example and not by way of limitation, FIG. 4 illustrates an example UI 410 that is associated with the predetermined concept “baseball”. The user may be able to provide a description of the predetermined concept associated with the image classifier. As an example and not by way of limitation, in UI 410, the user has inputted the description “Photos of baseballs”, which may indicate that the image classifier will be trained to recognize photos of baseballs (e.g., rather than depictions of the game of baseball being played). In particular embodiments, a predetermined concept may be associated with inappropriateness (e.g., violent, pornographic, or otherwise offensive content). As an example and not by way of limitation, the UI 410 allows a user to indicate whether the predetermined concept is associated with offensive content. Although this disclosure describes creating a new image classifier in a particular manner, this disclosure contemplates creating a new image classifier in any suitable manner.

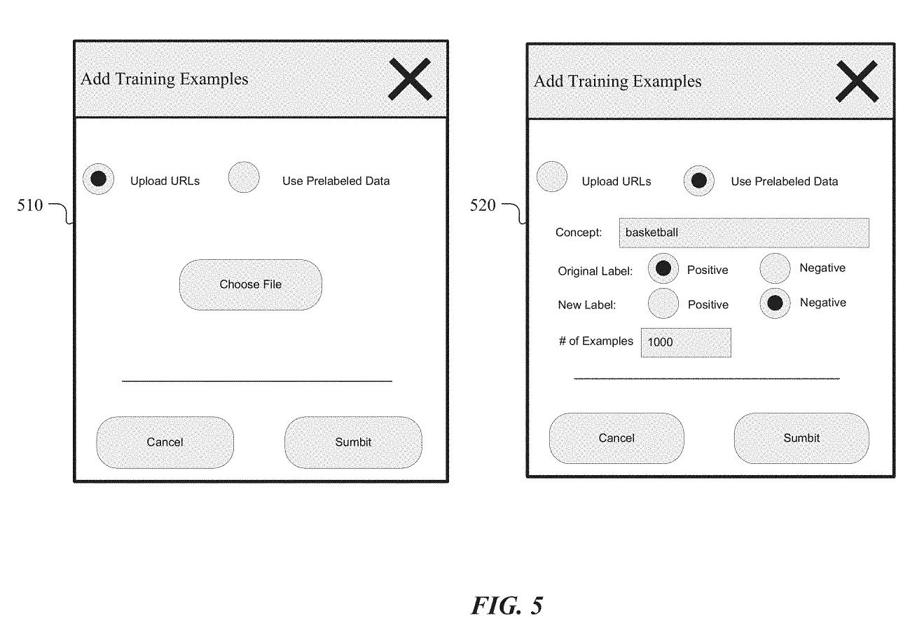

FIG. 5 illustrates example UIs 510 and 520 for adding training data. In particular embodiments, UI 510 or UI 520 may be provided to the user by a data addition module of a computer-vision platform. In particular embodiments, social-networking system 160 may access, for each of a plurality of input images, a feature vector that corresponds to the input image and maps it to a point in a d-dimensional vector space. In particular embodiments, social-networking system 160 may access feature vectors corresponding to an input image by receiving the input image. As an example and not by way of limitation, a user of a computer-vision platform may send, and social-networking system 160 may receive, feature vectors corresponding to input images. In particular embodiments, social-networking system 160 may access the feature vectors by receiving the input images corresponding to the feature vectors and generating the corresponding feature vectors based on the received input images. To generate feature vectors based on the corresponding images, social-networking system 160 may access a function \vec{π} to map the input images to corresponding feature vectors by feature extraction. A user may send the input images to social-networking system 160 directly or indirectly (e.g., by sending to social-networking system 160 a location of the feature vectors). As an example and not by way of limitation, UI 510 illustrates an example UI for a user to send to social-networking system 160 a file (e.g., a comma separated values (CSV) file) comprising a list of URLs, each of which may indicate the location of an input image. The input images may also be images created or stored by social-networking system 160. As another example and not by way of limitation, UI 520 illustrates an example where the user may indicate pre-labeled data as the input images, where the pre-labeled data may be stored by social-networking system 160. In particular embodiments, social-networking system 160 may access input images from a real-time database. As an example and not by way of limitation, an input image accessed by social-networking system 160 may be an image that was recently received by social-networking system 160. Although this disclosure describes accessing feature vectors corresponding to input images in a particular manner, this disclosure contemplates accessing feature vectors corresponding to input images in any suitable manner.

In particular embodiments, social-networking system 160 may access, for each of a plurality of input images, metadata indicating a relationship of the input image to a predetermined concept. The metadata may be accessed from a preexisting dataset or a dataset comprising the metadata may be created and accessed. The metadata associated with each input image may comprise a tag or a label indicating whether the image is associated with the predetermined concept. As an example and not by way of limitation, the metadata may indicate whether the input image depicts, represents, or is otherwise associated with or related to the predetermined concept. Metadata for an input image may comprise a “positive” label, which may indicate that the input image depicts an instance of the predetermined concept, or a “negative” label, which may indicate that the input image does not depict an instance of the predetermined concept. As an example and not by way of limitation, if the predetermined concept is “cat”, then metadata associated with each input image may indicate whether there is a cat in the input image. As another example and not by way of limitation, in UI 520, a user may have selected an option to use input images that have associated metadata (e.g., pre-labeled data). In UI 520, the user has selected to use 1,000 input images that have metadata indicating that the input images are associated with the concept “basketball”. The user of UI 520 may be using the predetermined concept “baseball”, and so the user may indicate that a positive label for the original concept (e.g., metadata indicating that the input image depicts a basketball) should be considered a negative label for the predetermined concept “baseball.” Social-networking system 160 may store metadata or labels for input images for later access (e.g., to retrain the image classifier, to train another image classifier, etc.). In particular embodiments, metadata may determine a positive or negative label for a plurality of concepts or for one or more categories of concepts. As an example and not by way of limitation, metadata for an input image may comprise a positive label for the predetermined concept “plastic toy.” A positive label for the predetermined concept “plastic toy” may be determined to be a negative label for the predetermined concepts “helicopter,” “car,” and “coffee cup.” A positive label for the predetermined concept “plastic toy” may also be determined to be a negative label for predetermined concepts in the category of “food,” which may comprise predetermined concepts such as “banana,” “pizza,” and “quiche.” In particular embodiments, the metadata associated with each input image may be provided by, altered by, defined by, or customized by a user. As an example and not by way of limitation, a user may provide a positive or negative label for an input image corresponding to a particular predetermined concept, or may provide, alter, define, or customize metadata in any other suitable manner. A user may also provide, define, or alter predetermined concepts (e.g., changing the name of a predetermined concept, creating and naming a new predetermined concept, etc.). In particular embodiments, the metadata may be generated by one or more trained image classifiers. As an example and not by way of limitation, an image classifier trained to recognize images of dogs may generate metadata for a plurality of input images that labels the input images as positive for the predetermined concept “dog.” The input images may be used to train an image classifier associated with the predetermined concept “canine” by using a positive label for “dog” as a positive label for “canine.” The input images may also be used to train an image classifier associated with the predetermined concept “wolf” by using a positive label for “dog” as a negative label for “wolf” In particular embodiments, UI 510 may allow a user to send a file indicating a location of input images and comprise metadata for each input image. As an example and not by way of limitation, UI 510 may allow a user to send a CSV file where each row of the CSV file may represent an input image, and where the CSV file comprises a first column of URLs indicating a location for each input image and second column comprising metadata indicating whether each input image is associated with the predetermined concept (e.g., “1” for a positive label and “−1” for a negative label). As another example and not by way of limitation, the user may send input images, and social-networking system 160 may display the input images to the user and provide the user a UI that may allow the user to add the corresponding metadata for the input images. In particular embodiments, the metadata corresponding to an image may comprise a tag added by a user of an online social network. As an example and not by way of limitation, a user of an online social network may post an input image on the online social network along with a metadata tag (e.g., “#cat”), which may indicate whether the image is associated with the predetermined concept. As another example and not by way of limitation, a first user of an online social network may post an input image depicting a cake on the online social network and a second user may associate the metadata tag “#cake” with the input image (e.g., by creating a post associated with the input image that comprises the metadata tag “#cake”). In particular embodiments, metadata associated with an input image may comprise a tag indicating whether the input image is inappropriate. As an example and not by way of limitation, metadata corresponding to input images depicting pornographic material may have a tag indicating that the input images are inappropriate. Although this disclosure describes accessing metadata corresponding to input images in a particular manner, this disclosure contemplates accessing metadata corresponding to input images in any suitable manner.

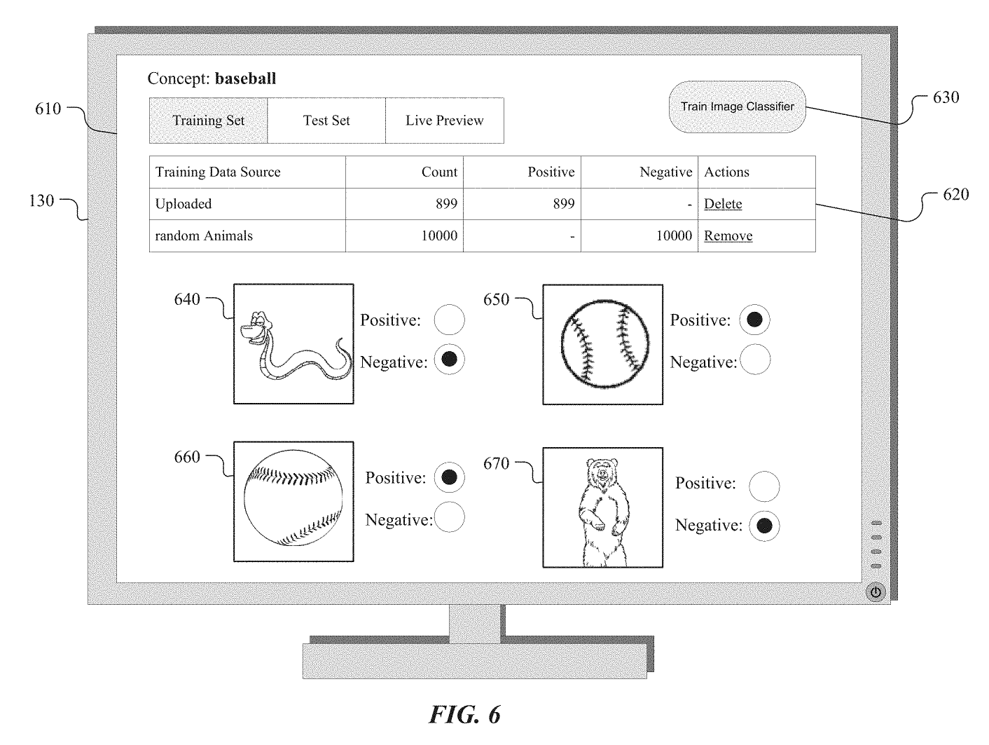

FIG. 6 illustrates an example UI 610 for training an image classifier. In particular embodiments, UI 610 may be provided to the user by a training module of a computer-vision platform. In particular embodiments, social-networking system 160 may train with machine learning an image classifier associated with the predetermined concept based on the feature vectors of the input images and the metadata indicating their respective relationships to the predetermined concept. Social-networking system 160 may provide a UI 610 for display on a user's client device 130. The UI 610 may display input images, such as example input images 640-670. Each of the input images may have metadata that comprises a positive or negative tag or label with respect to the predetermined concept associated with the image classifier. FIG. 6 depicts an example where the predetermined concept associated with the image classifier is “baseball.” In this example, input images 650 and 660 are labeled positive, as those input images depict a baseball. Input image 640, which depicts a snake, and input image 670, which depicts a bear, a labeled negative. As discussed above, an input image may have been pre-labeled or the user may have labeled the input image. UI 610 may allow the user to label the input images (e.g., add a label for an input image that does not have a label, alter an existing label of an input image, etc.). Social-networking system 160 may train with machine learning the image classifier based on the feature vectors of the input images and the metadata. In particular embodiments, social-networking system 160 may train the image classifier in response to user input indicating that training should begin. As an example and not by way of limitation, UI 610 may provide a user a button 630 that may allow a user to indicate that training should begin. In particular embodiments, social-networking system 160 may train the image classifier by supervised machine learning and the image classifier may comprise a trained function based on using the feature vectors corresponding to the input images as training data. In particular embodiments, social-networking system 160 may provide a display metric associated with the image classifier for display to the user. As an example and not by way of limitation, display metric 620 may be displayed to the user. Display metric 620 may indicate that the user has uploaded 899 input images that are labeled positive (i.e., the image is associated with the predetermined concept), and that 10,000 negative labeled input images will be used from a source titled “random Animals.” Although this disclosure describes training an image classifier in a particular manner, this disclosure contemplates training an image classifier in any suitable manner.

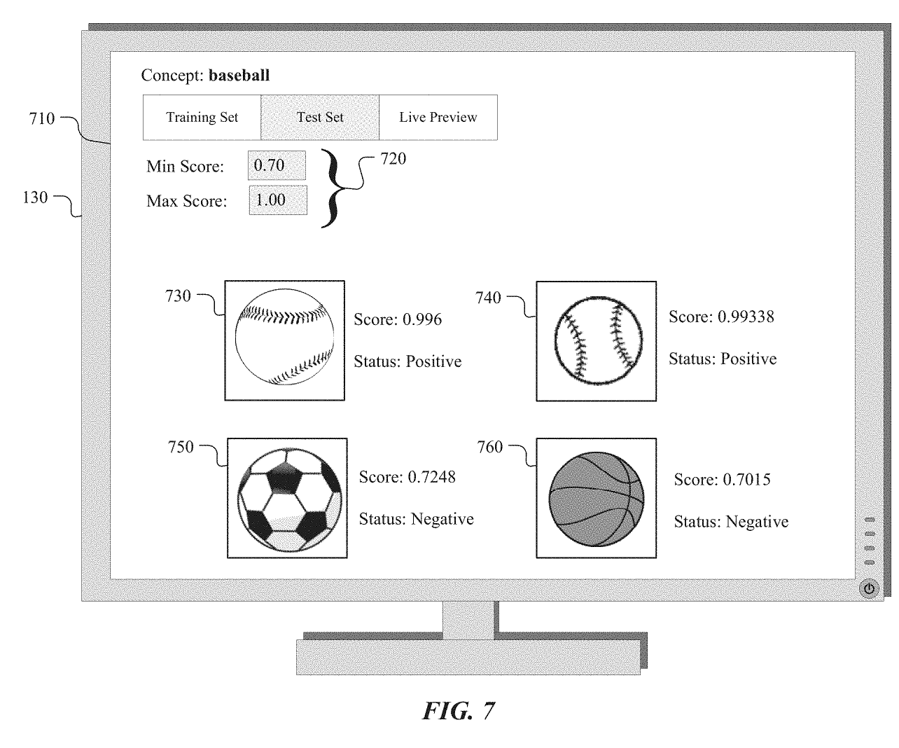

FIG. 7 illustrates an example UI 710 for displaying to a user input images and their respective scores. In particular embodiments, UI 710 may be provided to the user by a training module of a computer-vision platform. In particular embodiments, social-networking system 160 may calculate with the image classifier as trained a score indicating how closely related the input image is to the predetermined concept. As an example and not by way of limitation, the image classifier in FIG. 7 may be associated with the concept “baseball.” In particular embodiments, UI 710 may allow the user to view a subset of the input images. As an example and not by way of limitation, the user may use filter 720 to display input images for which the respective scores of the input images are between 1.00 and 0.70. Input images and the score corresponding to the input images may be displayed via UI 710. As an example and not by way of limitation, input images 730-760 are displayed by UI 710, along with their respective scores. In particular embodiments, UI 710 may display the information about the metadata for each input image. As an example and not by way of limitation, UI 710 may display metadata for images 730 and 740 comprising a positive label and metadata for images 750 and 760 comprising a negative label. Although this disclosure describes input images and scores in a particular manner, this disclosure contemplates input images and scores in any suitable manner.

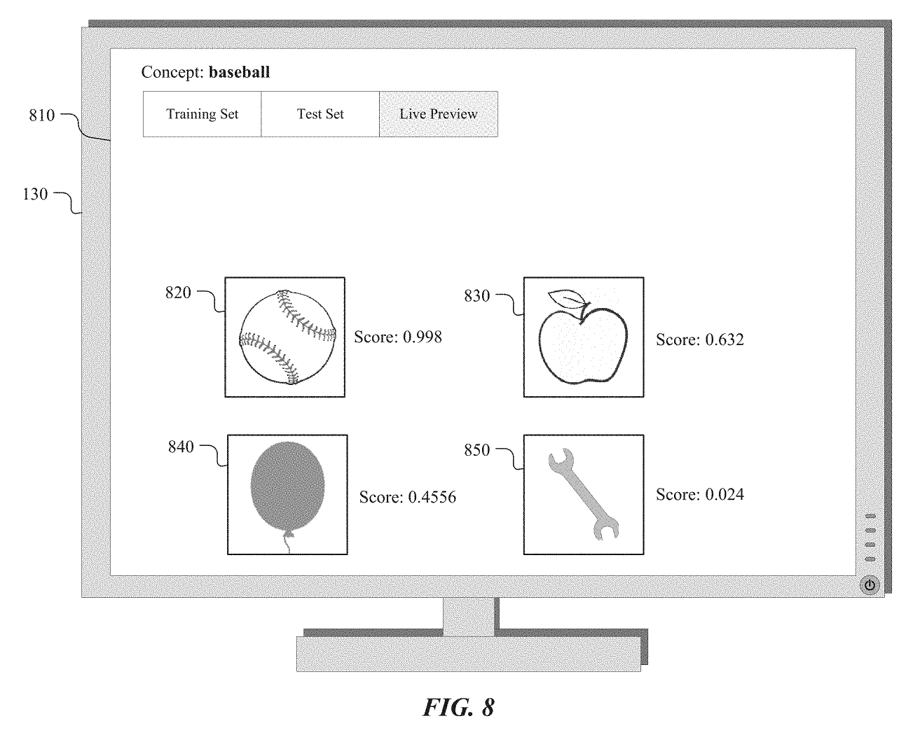

FIG. 8 illustrates an example UI 810 for displaying to a user evaluation images and their respective scores. In particular embodiments, UI 810 may be provided by an evaluation module of a computer-vision platform. In particular embodiments, social-networking system 160 may access for each of a plurality of evaluation images a feature vector that corresponds to the evaluation image and maps it to a point in the d-dimensional vector space. Social-networking system 160 may determine images to use as evaluation images. As an example and not by way of limitation, the user may indicate which images to use as evaluation images. As another example and not by way of limitation, a particular number of random images accessed by social-networking system 160 may be determined to be evaluation images. In particular embodiments, the plurality of evaluation images may be accessed from an online social networking system. As an example and not by way of limitation, social-networking system 160 may access images posted by users of an online social network for use as evaluation images. In particular embodiments, to access feature vectors corresponding to the evaluation images, social-networking system 160 may access a function \vec{π} to map the evaluation images to the corresponding feature vectors by feature extraction. As an example and not by way of limitation, for each evaluation image e, social-networking system may access a corresponding feature vector by calculating \vec{π}(e). In particular embodiments, social-networking system 160 may access feature vectors for the evaluation images directly without accessing the evaluation images themselves. Although this disclosure describes accessing evaluation images in a particular manner, this disclosure contemplates accessing evaluation images in any suitable manner.

In particular embodiments, social-networking system 160 may, for each evaluation image, calculate with the image classifier as trained a score indicating how closely related the evaluation image is to the predetermined concept, based on the feature vector corresponding to the evaluation image. As an example and not by way of limitation, the image classifier as trained may comprise a trained function R(\vec{x}) for which a feature vector \vec{x} is an input and a score indicating how closely related the evaluation image is to the predetermined concept is an output. For each evaluation image e, the score indicating how closely related the evaluation image is to the predetermined concept may be calculated as R(\vec{π}(e)). The score may indicate how related the image is to the predetermined concept. As an example and not by way of limitation, the score may range from 0 to 1, where a higher score may indicate a higher likelihood that the evaluation image is related to the predetermined concept. Although this disclosure describes calculating scores for evaluation images in a particular manner, this disclosure contemplates calculating scores for evaluation images in any suitable manner.

In particular embodiments, social-networking system 160 may provide for display to a user one or more of the evaluation images and their respective scores as calculated by the image classifier. As an example and not by way of limitation, social-networking system 160 may provide UI 810 to the user, which may display evaluation images 820-850. In particular embodiments, UI 810 may display the respective scores of evaluation images 820-850. As an example and not by way of limitation, evaluation image 820 may depict a baseball and have a score of 0.998, evaluation image 830 may depict an apple and have a score of 0.632, evaluation image 840 may depict a balloon and have a score of 0.4556, and evaluation image 850 may depict a wrench and have a score of 0.024. In particular embodiments, where evaluation images and respective scores are displayed to the user, the user may be able to determine whether the scores calculated by the image classifier are sufficient, or whether the image classifier should be trained using more or different input images based on the displayed evaluation images and respective scores. As an example and not by way of limitation, the image classifier in FIG. 8 may be associated with the predetermined concept “baseball.” That evaluation image 820 depicts a baseball and has a higher score than the other evaluation images 830-850 that do not depict a baseball may indicate that the image classifier is sufficiently trained. If evaluation images that receive high scores do not depict the predetermined concept, this may indicate to the user that the image classifier in insufficiently trained. Although this disclosure describes displaying evaluation images and scores in a particular manner, this disclosure contemplates displaying evaluation images and scores in any suitable manner.

In particular embodiments, social-networking system 160 may determine whether the image classifier is similar to a different image classifier based on a comparison of the scores calculated with the image classifier as trained for the each image of the plurality of evaluation images and scores calculated with the different image classifier for each image of the plurality of evaluation images, respectively. As an example and not by way of limitation, the image classifier may be associated with the predetermined concept “dog” and the different image classifier may be associated with the predetermined concept “canine.” The image classifier may calculate scores for each of a plurality of evaluation images that are similar to scores calculated for the evaluation images by the different image classifier. Based on determining that the scores calculated by the image classifier and the different image classifier are similar for the evaluation images, social-networking system 160 may determine that the image classifier is similar to the different image classifier. In particular embodiments, social-networking system 160 may provide for display to the user an indication that the image classifier is similar to the different image classifier (e.g., via an evaluation module of a computer-vision platform). As an example and not by way of limitation, a message indicating the similarity may be displayed to the user via a UI. Although this disclosure describes determining that image classifiers are similar in a particular manner, this disclosure contemplates determining that image classifiers are similar in any suitable manner.

In particular embodiments, social-networking system 160 may determine whether determine that the concept associated with the image classifier is visually similar to a different concept associated with the different image classifier. The image classifier may be determined to be similar to a different image classifier based on determining that the concept is visually similar to the different concept. As an example and not by way of limitation, the concept and the different concept may be determined to be visually similar if images that receive a high score (e.g., greater than a threshold score, a greater score than a threshold percentage of other images, etc.) calculated by the image classifier are similar to images that receive a high score calculated by the different image classifier. A first image and a second image may be determined to be similar based on a similarity metric of a feature vector corresponding to the first image and a feature vector corresponding to the second image (e.g., greater than a threshold similarity). In particular embodiments, social-networking system 160 may determine that the concept and a visually similar different concept are co-occurrences (e.g., an occurrence of the concept in a image is also an occurrence of the different concept in the image). As an example and not by way of limitation, the concept “Persian cat” and the different concept “cat” may be visually similar co-occurrences. A UI may inform the user that the concept associated with the image classifier is and the different concept associated with the different image classifier are co-occurrences and recommend that the user merge the image classifiers into one image classifier. In particular embodiments, social-networking system 160 may determine that the concept and a visually similar different concept are confounders (e.g., an occurrence of the concept in a image is not an occurrence of the different concept in the image). As an example and not by way of limitation, the concept “baseball player” and the different concept “cricket player” may be visually similar confounders. A UI may inform the user that the concept associated with the image classifier is and the different concept associated with the different image classifier are confounders and recommend that images depicting the different concept be used as input images with a negative label to train the image classifier. In particular embodiments, training an image classifier associated with a concept with negative labeled input images depicting a confounding different concept may result in the image classifier being able to more accurately distinguish between and calculate scores for images. Although this disclosure describes determining that a concept is visually similar to a different concept in a particular manner, this disclosure contemplates determining that a concept is visually similar to a different concept in any suitable manner.

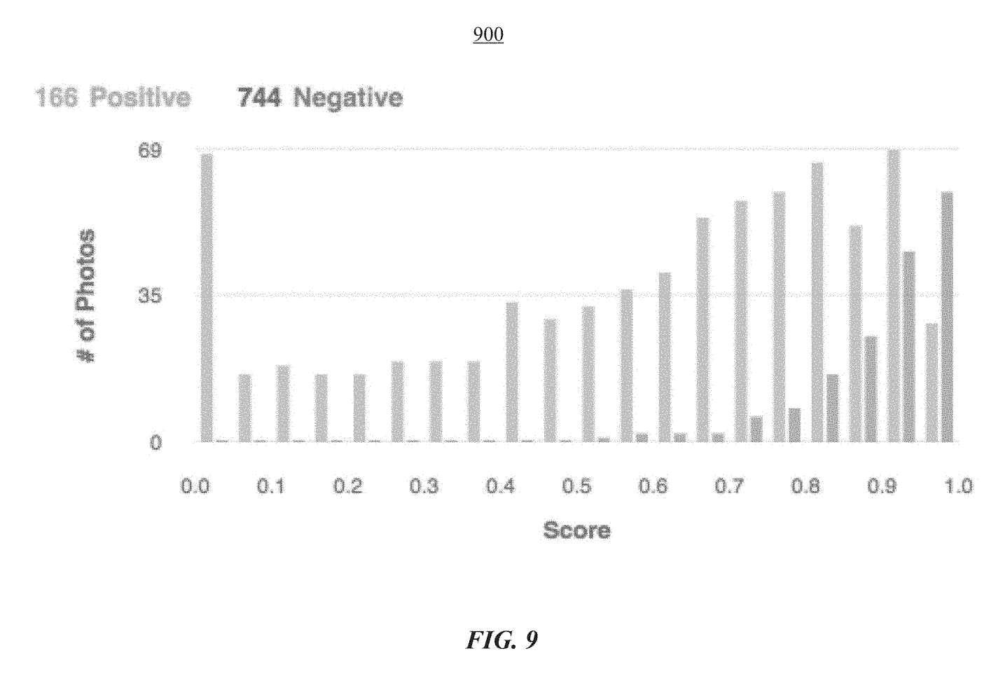

FIG. 9 illustrates an example display metric 900 associated with viewing input images. Display metric 900 may be a bar graph indicating the number of images that received a particular range of scores, separated by whether the image is a positive or a negative image. As an example and not by way of limitation, referencing FIG. 7, display metric 900 may be displayed by UI 710 as the user is viewing input images and their corresponding scores. In particular embodiments, display metric 900 may be displayed by a data addition module of a computer-vision platform. Although this disclosure describes particular display metrics, this disclosure contemplates any suitable display metrics.

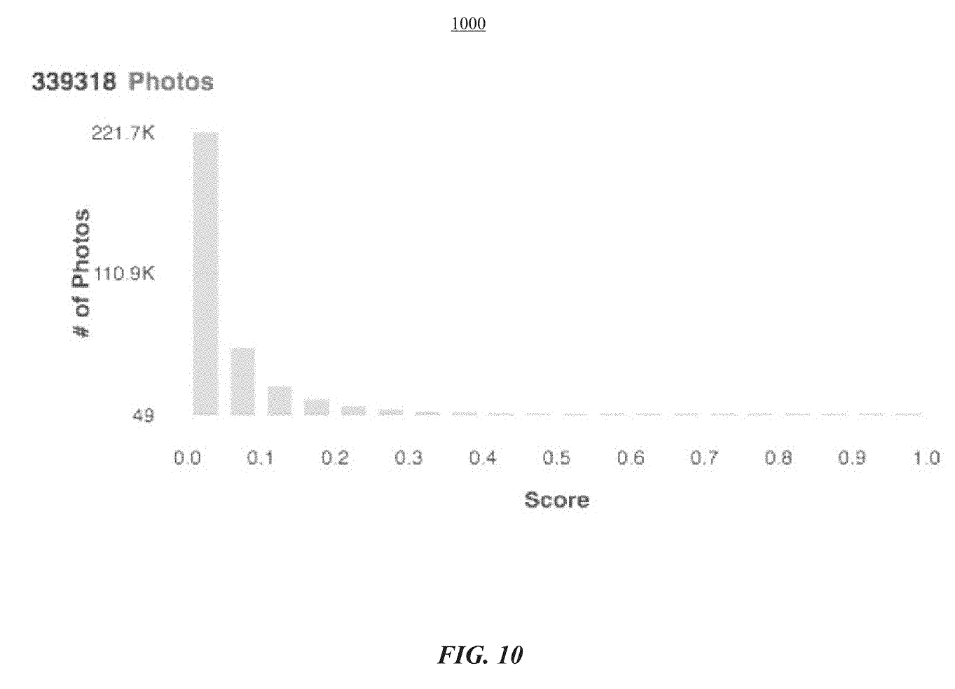

FIG. 10 illustrates an example display metric 1000 associated with viewing evaluation images. Display metric 1000 may be an example bar graph indicating a number of evaluation images corresponding to a range of scores. As an example and not by way of limitation, referencing FIG. 8, display metric 1000 may be displayed by UI 810 as the user is viewing evaluation images and their corresponding scores. In particular embodiments, display metric 1000 may be displayed by an evaluation module of a computer-vision platform. Although this disclosure describes particular display metrics, this disclosure contemplates any suitable display metrics.

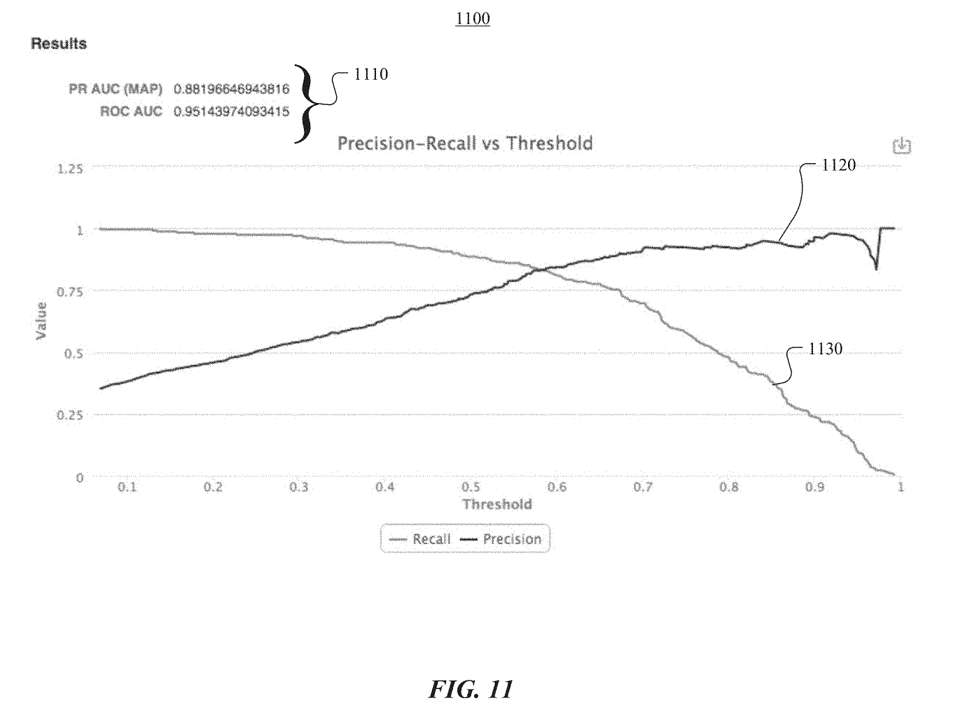

FIG. 11 illustrates an example display metric 1100 associated with training. Display metric 1100 may comprise curve 1120, which may represent the mean average precision of the image classifier. Display metric 1100 may comprise curve 1130, which may represent the receiver operator characteristic of the image classifier. Display metric 1100 may comprise metrics 1110, which may represent the area under the curves 1120 and 1130. As an example and not by way of limitation, display metric 1100 may be displayed to the user upon training the image classifier. In particular embodiments, display metric 1100 may be displayed by a training module of a computer-vision platform. Although this disclosure describes particular display metrics, this disclosure contemplates any suitable display metrics.

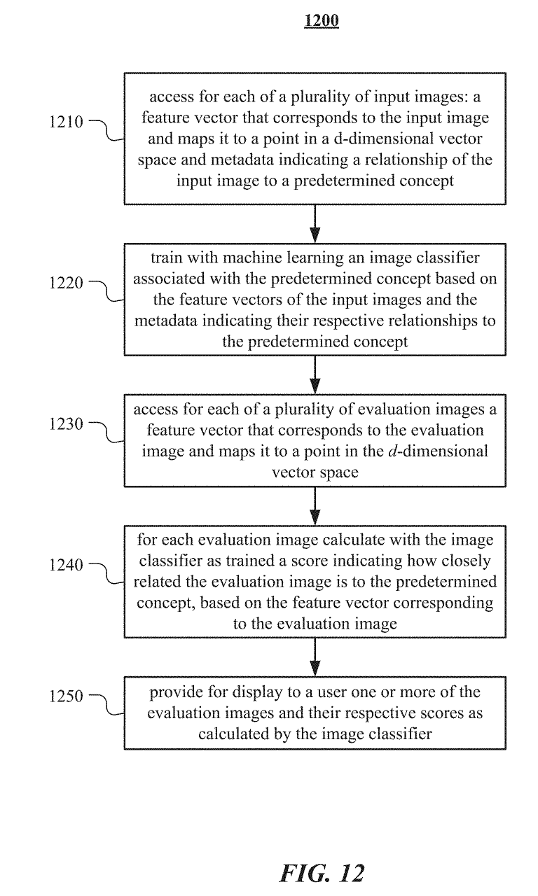

FIG. 12 illustrates an example method 1200 for training an image classifier. The method may begin at step 1210, where social-networking system 160 may access for each of a plurality of input images: a feature vector that corresponds to the input image and maps it to a point in a d-dimensional vector space and metadata indicating a relationship of the input image to a predetermined concept. At step 1220, social-networking system 160 may train with machine learning an image classifier associated with the predetermined concept based on the feature vectors of the input images and the metadata indicating their respective relationships to the predetermined concept. At step 1230, social-networking system 160 may access for each of a plurality of evaluation images a feature vector that corresponds to the evaluation image and maps it to a point in the d-dimensional vector space. At step 1240, social-networking system 160 may for each evaluation image calculate with the image classifier as trained a score indicating how closely related the evaluation image is to the predetermined concept, based on the feature vector corresponding to the evaluation image. At step 1250, social-networking system 160 may provide for display to a user one or more of the evaluation images and their respective scores as calculated by the image classifier. Particular embodiments may repeat one or more steps of the method of FIG. 12, where appropriate. Although this disclosure describes and illustrates particular steps of the method of FIG. 12 as occurring in a particular order, this disclosure contemplates any suitable steps of the method of FIG. 12 occurring in any suitable order. Moreover, although this disclosure describes and illustrates an example method for training an image classifier including the particular steps of the method of FIG. 12, this disclosure contemplates any suitable method for training an image classifier including any suitable steps, which may include all, some, or none of the steps of the method of FIG. 12, where appropriate. Furthermore, although this disclosure describes and illustrates particular components, devices, or systems carrying out particular steps of the method of FIG. 12, this disclosure contemplates any suitable combination of any suitable components, devices, or systems carrying out any suitable steps of the method of FIG. 12.

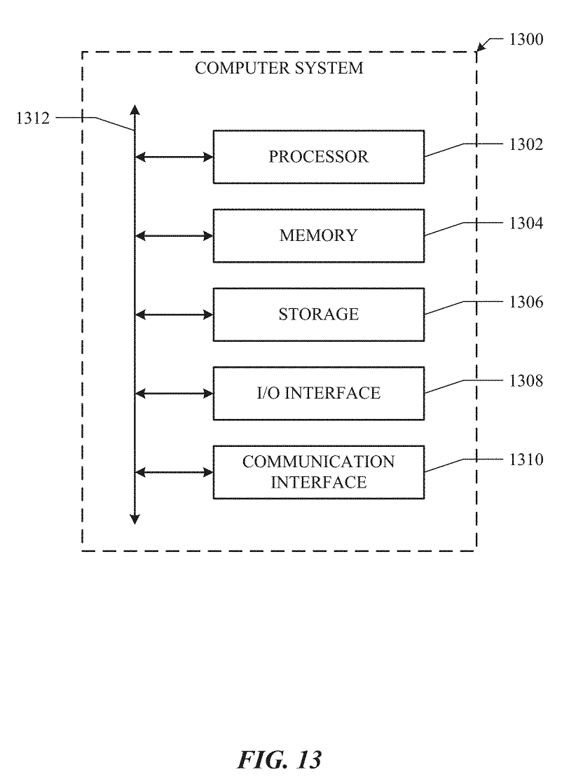

FIG. 13 illustrates an example computer system 1300. In particular embodiments, one or more computer systems 1300 perform one or more steps of one or more methods described or illustrated herein. In particular embodiments, one or more computer systems 1300 provide functionality described or illustrated herein. In particular embodiments, software running on one or more computer systems 1300 performs one or more steps of one or more methods described or illustrated herein or provides functionality described or illustrated herein. Particular embodiments include one or more portions of one or more computer systems 1300. Herein, reference to a computer system may encompass a computing device, and vice versa, where appropriate. Moreover, reference to a computer system may encompass one or more computer systems, where appropriate.

This disclosure contemplates any suitable number of computer systems 1300. This disclosure contemplates computer system 1300 taking any suitable physical form. As example and not by way of limitation, computer system 1300 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 1300 may include one or more computer systems 1300; be unitary or distributed; span multiple locations; span multiple machines; span multiple data centers; or reside in a cloud, which may include one or more cloud components in one or more networks. Where appropriate, one or more computer systems 1300 may perform without substantial spatial or temporal limitation one or more steps of one or more methods described or illustrated herein. As an example and not by way of limitation, one or more computer systems 1300 may perform in real time or in batch mode one or more steps of one or more methods described or illustrated herein. One or more computer systems 1300 may perform at different times or at different locations one or more steps of one or more methods described or illustrated herein, where appropriate.

In particular embodiments, computer system 1300 includes a processor 1302, memory 1304, storage 1306, an input/output (I/O) interface 1308, a communication interface 1310, and a bus 1312. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1302 includes hardware for executing instructions, such as those making up a computer program. As an example and not by way of limitation, to execute instructions, processor 1302 may retrieve (or fetch) the instructions from an internal register, an internal cache, memory 1304, or storage 1306; decode and execute them; and then write one or more results to an internal register, an internal cache, memory 1304, or storage 1306. In particular embodiments, processor 1302 may include one or more internal caches for data, instructions, or addresses. This disclosure contemplates processor 1302 including any suitable number of any suitable internal caches, where appropriate. As an example and not by way of limitation, processor 1302 may include one or more instruction caches, one or more data caches, and one or more translation lookaside buffers (TLBs). Instructions in the instruction caches may be copies of instructions in memory 1304 or storage 1306, and the instruction caches may speed up retrieval of those instructions by processor 1302. Data in the data caches may be copies of data in memory 1304 or storage 1306 for instructions executing at processor 1302 to operate on; the results of previous instructions executed at processor 1302 for access by subsequent instructions executing at processor 1302 or for writing to memory 1304 or storage 1306; or other suitable data. The data caches may speed up read or write operations by processor 1302. The TLBs may speed up virtual-address translation for processor 1302. In particular embodiments, processor 1302 may include one or more internal registers for data, instructions, or addresses. This disclosure contemplates processor 1302 including any suitable number of any suitable internal registers, where appropriate. Where appropriate, processor 1302 may include one or more arithmetic logic units (ALUs); be a multi-core processor; or include one or more processors 1302. Although this disclosure describes and illustrates a particular processor, this disclosure contemplates any suitable processor.

In particular embodiments, memory 1304 includes main memory for storing instructions for processor 1302 to execute or data for processor 1302 to operate on. As an example and not by way of limitation, computer system 1300 may load instructions from storage 1306 or another source (such as, for example, another computer system 1300) to memory 1304. Processor 1302 may then load the instructions from memory 1304 to an internal register or internal cache. To execute the instructions, processor 1302 may retrieve the instructions from the internal register or internal cache and decode them. During or after execution of the instructions, processor 1302 may write one or more results (which may be intermediate or final results) to the internal register or internal cache. Processor 1302 may then write one or more of those results to memory 1304. In particular embodiments, processor 1302 executes only instructions in one or more internal registers or internal caches or in memory 1304 (as opposed to storage 1306 or elsewhere) and operates only on data in one or more internal registers or internal caches or in memory 1304 (as opposed to storage 1306 or elsewhere). One or more memory buses (which may each include an address bus and a data bus) may couple processor 1302 to memory 1304. Bus 1312 may include one or more memory buses, as described below. In particular embodiments, one or more memory management units (MMUs) reside between processor 1302 and memory 1304 and facilitate accesses to memory 1304 requested by processor 1302. In particular embodiments, memory 1304 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1304 may include one or more memories 1304, where appropriate. Although this disclosure describes and illustrates particular memory, this disclosure contemplates any suitable memory.

In particular embodiments, storage 1306 includes mass storage for data or instructions. As an example and not by way of limitation, storage 1306 may include a hard disk drive (HDD), a floppy disk drive, flash memory, an optical disc, a magneto-optical disc, magnetic tape, or a Universal Serial Bus (USB) drive or a combination of two or more of these. Storage 1306 may include removable or non-removable (or fixed) media, where appropriate. Storage 1306 may be internal or external to computer system 1300, where appropriate. In particular embodiments, storage 1306 is non-volatile, solid-state memory. In particular embodiments, storage 1306 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1306 taking any suitable physical form. Storage 1306 may include one or more storage control units facilitating communication between processor 1302 and storage 1306, where appropriate. Where appropriate, storage 1306 may include one or more storages 1306. Although this disclosure describes and illustrates particular storage, this disclosure contemplates any suitable storage.

In particular embodiments, I/O interface 1308 includes hardware, software, or both, providing one or more interfaces for communication between computer system 1300 and one or more I/O devices. Computer system 1300 may include one or more of these I/O devices, where appropriate. One or more of these I/O devices may enable communication between a person and computer system 1300. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1308 for them. Where appropriate, I/O interface 1308 may include one or more device or software drivers enabling processor 1302 to drive one or more of these I/O devices. I/O interface 1308 may include one or more I/O interfaces 1308, where appropriate. Although this disclosure describes and illustrates a particular I/O interface, this disclosure contemplates any suitable I/O interface.

In particular embodiments, communication interface 1310 includes hardware, software, or both providing one or more interfaces for communication (such as, for example, packet-based communication) between computer system 1300 and one or more other computer systems 1300 or one or more networks. As an example and not by way of limitation, communication interface 1310 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1310 for it. As an example and not by way of limitation, computer system 1300 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1300 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1300 may include any suitable communication interface 1310 for any of these networks, where appropriate. Communication interface 1310 may include one or more communication interfaces 1310, where appropriate. Although this disclosure describes and illustrates a particular communication interface, this disclosure contemplates any suitable communication interface.

In particular embodiments, bus 1312 includes hardware, software, or both coupling components of computer system 1300 to each other. As an example and not by way of limitation, bus 1312 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1312 may include one or more buses 1312, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising:
by one or more computing devices, accessing for each of a plurality of input images:
a feature vector that corresponds to the input image and maps it to a point in a d-dimensional vector space; and
metadata indicating a relationship of the input image to a predetermined concept;
by one or more computing devices, training with machine learning an image classifier associated with the predetermined concept based on the feature vectors of the input images and the metadata indicating their respective relationships to the predetermined concept;
by one or more computing devices, accessing for each of a plurality of evaluation images a feature vector that corresponds to the evaluation image and maps it to a point in the d-dimensional vector space;
by one or more computing devices, for each evaluation image calculating with the image classifier as trained a score indicating how closely related the evaluation image is to the predetermined concept, based on the feature vector corresponding to the evaluation image; and
by one or more computing devices, providing for display to a user one or more of the evaluation images and their respective scores as calculated by the image classifier.

2. The method of claim 1, wherein, for each input image, the metadata comprises a tag indicating whether the image is associated with the predetermined concept.

3. The method of claim 1, wherein:
the predetermined concept is associated with inappropriateness; and
for each input image, the metadata comprises a tag indicating whether the input image is inappropriate.

4. The method of claim 1, wherein, for each input image, the metadata comprises a tag added by a user of an online social networking system.

5. The method of claim 1, wherein the plurality of evaluation images are accessed from an online social networking system.

6. The method of claim 1 furthering comprising, by one or more computing devices, providing a display metric associated with the image classifier for display to the user.

7. The method of claim 1, further comprising:
by one or more computing devices, determining whether the image classifier is similar to a different image classifier based on a comparison of the scores calculated with the image classifier as trained for the each image of the plurality of evaluation images and scores calculated with the different image classifier for each image of the plurality of evaluation images, respectively; and
by one or more computing devices, providing for display to the user an indication that the image classifier is similar to the different image classifier.

8. The method of claim 1, further comprising, by one or more computing devices, providing for display to a user one or more of the input images and their respective scores as calculated by the image classifier.

9. One or more computer-readable non-transitory storage media embodying software that is operable when executed to:
access for each of a plurality of input images:
a feature vector that corresponds to the input image and maps it to a point in a d-dimensional vector space; and
metadata indicating a relationship of the input image to a predetermined concept;
train with machine learning an image classifier associated with the predetermined concept based on the feature vectors of the input images and the metadata indicating their respective relationships to the predetermined concept;
access for each of a plurality of evaluation images a feature vector that corresponds to the evaluation image and maps it to a point in the d-dimensional vector space;
for each evaluation image, calculate with the image classifier as trained a score indicating how closely related the evaluation image is to the predetermined concept, based on the feature vector corresponding to the evaluation image; and
provide for display to a user one or more of the evaluation images and their respective scores as calculated by the image classifier.

10. The media of claim 9, wherein, for each input image, the metadata comprises a tag indicating whether the image is associated with the predetermined concept.

11. The media of claim 9, wherein:
the predetermined concept is associated with inappropriateness; and
for each input image, the metadata comprises a tag indicating whether the input image is inappropriate.

12. The media of claim 9, wherein, for each input image, the metadata comprises a tag added by a user of an online social networking system.

13. The media of claim 9, wherein the plurality of evaluation images are accessed from an online social networking system.

14. The media of claim 9, wherein the software is further operable when executed to provide a display metric associated with the image classifier for display to the user.

15. The media of claim 9, wherein the software is further operable when executed to:
determine whether the image classifier is similar to a different image classifier based on a comparison of the scores calculated with the image classifier as trained for the each image of the plurality of evaluation images and scores calculated with the different image classifier for each image of the plurality of evaluation images, respectively; and
provide for display to the user an indication that the image classifier is similar to the different image classifier.

16. The media of claim 9, wherein the software is further operable when executed to provide for display to a user one or more of the input images and their respective scores as calculated by the image classifier.

17. A system comprising:
one or more processors; and
a memory coupled to the processors and comprising instructions operable when executed by the processors to cause the processors to:
access for each of a plurality of input images:
a feature vector that corresponds to the input image and maps it to a point in a d-dimensional vector space; and
metadata indicating a relationship of the input image to a predetermined concept;
train with machine learning an image classifier associated with the predetermined concept based on the feature vectors of the input images and the metadata indicating their respective relationships to the predetermined concept;
access for each of a plurality of evaluation images a feature vector that corresponds to the evaluation image and maps it to a point in the d-dimensional vector space;
for each evaluation image, calculate with the image classifier as trained a score indicating how closely related the evaluation image is to the predetermined concept, based on the feature vector corresponding to the evaluation image; and
provide for display to a user one or more of the evaluation images and their respective scores as calculated by the image classifier.

18. The system of claim 17, wherein, for each input image, the metadata comprises a tag indicating whether the image is associated with the predetermined concept.

19. The system of claim 17, wherein:
the predetermined concept is associated with inappropriateness; and
for each input image, the metadata comprises a tag indicating whether the input image is inappropriate.

20. The system of claim 17, wherein, for each input image, the metadata comprises a tag added by a user of an online social networking system.
